(19) United States
(12) Patent Application Publication
(10) Pub. No.: US 2024/0093073 A1
(43) Pub. Date: Mar. 21, 2024

(54) Visible-Laser-Curable or Infrared-Laser-Curable Cationically Polymerizable Epoxy Resin Composition

(71) Applicant: Henkel AG & Co. KGaA, Duesseldorf (DE)

(72) Inventors: Shingo Tsuno, Kanagawa (JP); Takayuki Kanno, Kanagawa (JP); Shigeo Harada, Kanagawa (JP)

(21) Appl. No.: 18/506,572

(22) Filed: Nov. 10, 2023

Related U.S. Application Data
(63) Continuation of application No. PCT/JP2022/020119, filed on May 12, 2022.

(30) Foreign Application Priority Data
May 12, 2021 (JP) 2021-081236

(51) Int. Cl. C09J 163/10; C09J 5/06; C09J 11/04; C09J 163/00

(52) U.S. Cl. CPC C09J 163/10; C09J 5/06; C09J 11/04; C09J 163/00; C09J 2463/00

(57) ABSTRACT

Provided is a visible-laser-curable or infrared-laser-curable resin composition that cures in a shorter time and with less energy. A visible-laser-curable or infrared-laser-curable cationically polymerizable epoxy resin composition comprising (A) an epoxy resin and (B) an acid generator.

### TECHNICAL FIELD

The present invention relates to a visible-laser-curable or infrared-laser-curable cationically polymerizable epoxy resin composition.

### BACKGROUND ART

Visible or infrared lasers are widely used in welding because they can be intensively applied to a target area. For the same reason, visible or infrared lasers are also used to cure heat-curable adhesives.

Adhesives containing dicyandiamide or imidazole, and anionically polymerizable adhesives are widely used as techniques for curing heat-curable adhesives with visible or infrared lasers (Patent Literature (PTL) 1). However, these adhesives require high energy; for example, when a heating oven is used, the temperature should be 150° C. or higher. Such curing conditions are suitable for bonding metals, such as bonding automobile body panels, but not suitable for bonding optical components, such as camera module assemblies and electronic sensor assemblies. In terms of the characteristics of these components and the specifications of finished products, exposure of these components to high temperatures is not preferable. In addition, optical components may deviate from predetermined positions under the effect of high temperatures, which should be avoided in terms of the specifications of finished products.

Thus, when a lens holder is bonded to a base holder in a camera module, a method is used in which these are temporarily secured with UV so that they do not deviate from their positions, and final curing is performed in a heating oven until the desired degree of curing is reached.

In visible-laser-curable or infrared-laser-curable adhesives containing dicyandiamide or imidazole, and visible-laser-curable or infrared-laser-curable anionically polymerizable adhesives, mainly black pigments are often added to absorb the laser and release thermal energy in order to further promote curing (PTL2 and PTL3).

### SUMMARY OF INVENTION

### Technical Problem

The present inventors found that conventional visible-laser-curable or infrared-laser-curable adhesives to which a pigment is added to further promote curing, i.e., those containing dicyandiamide or imidazole, and those being anionically polymerizable, have the following problems. Specifically, in these conventional adhesives, only the area around the pigment becomes extremely hot, resulting in deterioration of the physical properties of the cured product and decomposition. There are also problems such as curing of only the surface where the pigment is present and burning due to excessive absorption energy concentrated on the surface.

An object of the present invention is to provide a visible-laser-curable or infrared—laser-curable resin composition that cures in a shorter time and with less energy than conventional techniques.

### Solution to Problem

The present inventors conducted extensive research to achieve the above object and found that the object can be achieved by a cationically polymerizable epoxy resin composition comprising (A) an epoxy resin and (B) an acid generator. The present invention has been accomplished by further conducting research based on this finding. The present invention includes the following embodiments.

### Item 1.

A visible-laser-curable or infrared-laser-curable cationically polymerizable epoxy resin composition comprising:
(A) an epoxy resin; and
(B) an acid generator.

### Item 2.

The cationically polymerizable epoxy resin composition according to Item 1, wherein the epoxy resin (A) comprises an alicyclic epoxy resin.

### Item 3.

The cationically polymerizable epoxy resin composition according to Item 2, wherein the epoxy resin (A) further comprises a glycidyl ether epoxy resin.

### Item 4.

The cationically polymerizable epoxy resin composition according to any one of Items 1 to 3, being curable at a visible or infrared laser having a wavelength of 600 to 1200 nm.

### Item 5.

The cationically polymerizable epoxy resin composition according to any one of Items 1 to 4, further comprising:
(C) an inorganic filler.

### Item 6.

The cationically polymerizable epoxy resin composition according to any one of Items 1 to 5, wherein the acid generator is a photoacid generator or a thermal acid generator.

### Item 7.

The cationically polymerizable epoxy resin composition according to any one of Items 1 to 6, for use in at least one application selected from the group consisting of metal bonding, camera module assembly, and electronic sensor assembly.

### Item 8.

Use of a cationically polymerizable epoxy resin composition in curing with a visible or infrared laser, the composition comprising:
(A) an epoxy resin; and
(B) an acid generator.

### Item 9.

A method of curing a cationically polymerizable epoxy resin composition, the method comprising irradiating the cationically polymerizable epoxy resin composition with a visible or infrared laser to cure the composition, and the cationically polymerizable epoxy resin composition comprising:
(A) an epoxy resin; and
(B) an acid generator.

### Advantageous Effects of Invention

Using the visible-laser-curable or infrared-laser-curable resin composition of the present invention enables curing in a shorter time and with less energy than conventional techniques.

### DESCRIPTION OF EMBODIMENTS

### (A) Epoxy Resin

The epoxy resin for use in the present invention is not particularly limited as long as the epoxy resin can undergo cationic polymerization. The reaction mechanism of cationic polymerization of epoxy resins is well known. Specifically, the epoxy resin for use in the present invention can be any polymerization system whose growing chain is a carbon cation (carbocation). The epoxy resin for use in the present invention forms a carbocation by reacting with an acid generated by an acid generator. Growth reaction occurs between this carbocation and the epoxy resin for use in the present invention, thereby ultimately providing a cured product.

The epoxy resin for use in the present invention may be a single epoxy resin or a combination of two or more epoxy resins, if necessary.

In terms of excellent curability, the epoxy resin for use in the present invention preferably contains an alicyclic epoxy resin. The alicyclic epoxy resin refers to an epoxy resin that has an alicyclic ring in its molecule, with part of the carbon-carbon bonds that form the alicyclic ring being shared with an epoxy ring. The alicyclic epoxy resin for use can be a known alicyclic epoxy resin.

When the epoxy resin for use in the present invention contains an alicyclic epoxy resin, the epoxy resin contains the alicyclic epoxy resin in an amount of preferably 3 wt. % or more, more preferably 5 wt. % or more, and still more preferably 10 wt. % or more based on the entire epoxy resin in terms of curability.

The alicyclic epoxy resin for use in the present invention has an epoxy equivalent of, for example, 100 to 500, preferably 100 to 400, and more preferably 100 to 300.

Examples of the alicyclic epoxy resin for use in the present invention include, but not particularly limited to, (3′,4′-epoxycyclohexane)methyl 3,4-epoxycyclohexylcarboxylate (Celloxide 2021P (CEL2021P) produced by Daicel Corporation), 3,4-epoxycyclohexylmethyl-3′,4′-epoxycyclohexanecarboxylate modified ε-caprolactone (Celloxide 2081 (CEL2081) produced by Daicel Corporation), 1,2-epoxy-4-vinylcyclohexane (Celloxide 2000 (CEL2000) produced by Daicel Corporation), (Celloxide 8010 (CEL8010) produced by Daicel Corporation), (KR-470 produced by Shin-Etsu Chemical Co., Ltd.), and the like.

In terms of imparting flexibility to a cured product, the epoxy resin for use in the present invention preferably contains at least one epoxy resin selected from the group consisting of a glycidyl ether epoxy resin and a glycidyl ester epoxy resin. Compared to alicyclic epoxy resins, these epoxy resins undergo a slower growth reaction, so the curing reaction persists after laser irradiation, and the molecular weight grows into only about a few thousands. Thus, these epoxy resins can impart preferable flexibility to the final cured product.

The glycidyl ether epoxy resin and glycidyl ester epoxy resin for use in the present invention each have an epoxy equivalent of, for example, 100 to 1000, preferably 100 to 800, and more preferably 100 to 600.

The glycidyl ether epoxy resin and glycidyl ester epoxy resin for use in the present invention are preferably liquid or semi-solid at room temperature (about 23° C.) but can be dissolved and used if they are solid.

The glycidyl ether epoxy resin and glycidyl ester epoxy resin are preferably those with an aromatic structure in the main chain. The glycidyl ether epoxy resin and glycidyl ester epoxy resin may have a polycyclic aromatic structure (naphthalene, anthracene, etc.) in the main chain.

The epoxy resin to be added for imparting flexibility to a cured product is preferably a glycidyl ether epoxy resin. Examples of glycidyl ether epoxy resins include bisphenol-type glycidyl ethers, and the like.

Bisphenol-type glycidyl ethers include bisphenol A glycidyl ether, bisphenol F glycidyl ether, bisphenol AP glycidyl ether, bisphenol B glycidyl ether, bisphenol C glycidyl ether, bisphenol E glycidyl ether, bisphenol G glycidyl ether, and the like.

Preferable bisphenol A glycidyl ether includes (EPICLON 840 produced by DIC Corporation), (EPICLON 840S produced by DIC Corporation), (EPICLON 850 produced by DIC Corporation), (EPICLON 850S produced by DIC Corporation), (EXA-850CRP produced by DIC Corporation), (EXA-850LC produced by DIC Corporation), (EXA-860 produced by DIC Corporation), (EXA-1050 produced by DIC Corporation), (EXA-1055 produced by DIC Corporation), (825 produced by Mitsubishi Chemical Corporation), (827 produced by Mitsubishi Chemical Corporation), (828 produced by Mitsubishi Chemical Corporation), (1001 produced by Mitsubishi Chemical Corporation), (1002 produced by Mitsubishi Chemical Corporation), (RE-310S produced by Nippon Kayaku Co., Ltd.), and the like.

Preferable bisphenol F glycidyl ether includes (EXA-830 produced by DIC Corporation), (EXA-830S produced by DIC Corporation), (EXA-835 produced by DIC Corporation), (EXA-830CRP produced by DIC Corporation), (EXA830LVP produced by DIC Corporation), (EXA835LV produced by DIC Corporation), (806 produced by Mitsubishi Chemical Corporation), (806H produced by Mitsubishi Chemical Corporation), (807 produced by Mitsubishi Chemical Corporation), and (RE-303SL produced by Nippon Kayaku Co., Ltd.); and phenol aralkyl epoxy includes (NC3000L produced by Nippon Kayaku Co., Ltd.), (NC2000L produced by Nippon Kayaku Co., Ltd.), and the like.

If the epoxy resin for use in the present invention contains a glycidyl ether epoxy resin and/or a glycidyl ester epoxy resin, the epoxy resin contains the glycidyl ether epoxy resin and the glycidyl ester epoxy resin in a total amount of preferably 3 wt. % or more, more preferably 5 wt. % or more, and still more preferably 10 wt. % or more based on the entire epoxy resin in terms of imparting flexibility to a cured product.

### (B) Acid Generator

The acid generator for use in the present invention is not particularly limited as long as it generates an acid directly or indirectly by using a visible or infrared laser, and as long as the acid reacts with the epoxy resin (A) to produce a carbocation.

Examples of the acid generator that generates an acid directly or indirectly by using a visible or infrared laser mentioned above include photoacid generators and the like. A photoacid generator is a compound that generates an acid by being irradiated with light. The photoacid generator has a moiety that absorbs light and a moiety that serves as the source of an acid in the molecule. Examples include, but are not particularly limited to, onium salts with cationic and anionic moieties, and the like. In these onium salts, the cationic moiety corresponds to the moiety that absorbs light, while the anionic moiety serves as the source of an acid.

As the cationic moiety, the onium salts mentioned above may contain a sulfonium ion, an iodonium ion, a phosphonium ion, a quaternary ammonium ion, a diazonium ion, or the like. The sulfonium ion for use may be, for example, a triarylsulfonium ion.

As the anionic moiety, the onium salts may contain PF₆-, SbF₆-, BF₄-, or the like.

Examples of the photoacid generator include CPI-100P, CPI-101A, CPI-200K, CPI-210S, CPI-310B, CPI-310FG, CPI-410S, and IK-1, all of which are produced by SanApro Ltd.; IRGACURE 250 and IRGACURE 270, both of which are produced by Ciba Specialty Chemicals Inc.; BLUESIL PI 2074, produced by Elkem; and the like.

Examples of the acid generator that generates an acid directly or indirectly by using a visible or infrared laser mentioned above include thermal acid generators and the like. A thermal acid generator is a compound that generates an acid by absorbing heat. The heat generated by a visible or infrared laser can allow the thermal acid generator to generate an acid. If necessary, for example, an inorganic filler or the like may be appropriately incorporated in the cationically polymerizable epoxy resin composition of the present invention, whereby heat can be more easily generated by visible or infrared laser irradiation, and an acid can be more easily generated from the thermal acid generator.

Examples of the thermal acid generator include (TGA CXC1612 and TGA CXC1821, both of which produced by King Industries, Inc.), (San-aid SI-B2A, produced by Sanshin Chemical Industry Co., Ltd.), (San-aid SI-B7, produced by Sanshin Chemical Industry Co., Ltd.), (San-aid SI-B3A, produced by Sanshin Chemical Industry Co., Ltd.), (San-aid SI-B3, produced by Sanshin Chemical Industry Co., Ltd.), (San-aid SI-B5, produced by Sanshin Chemical Industry Co., Ltd.), and the like.

The acid generator for use in the present invention may be a single acid generator or a combination of two or more acid generators, if necessary.

The cationically polymerizable epoxy resin composition of the present invention comprises the acid generator in an amount of, for example, 0.01 to 10 wt. %, preferably 0.1 to 8 wt. %, more preferably 0.1 to 5 wt. %, and still more preferably 0.1 to 3 wt. % based on the entire cationically polymerizable epoxy resin composition.

### (C) Inorganic Filler

The cationically polymerizable epoxy resin composition of the present invention may further comprise an inorganic filler.

The inorganic filler used in the present invention may be a single inorganic filler or a combination of two or more inorganic fillers, if necessary.

Examples of the inorganic filler used in the present invention include silica fillers such as colloidal silica, hydrophobic silica, fine silica, and nano-silica, as well as acrylic beads, glass beads, urethane beads, bentonite, acetylene black, Ketjen black, and the like.

The inorganic filler used in the present invention can be one having a volume average particle size (if the filler is not granular, its maximum weight average diameter) of, for example, 0.01 to 50 μm, preferably 0.1 to 40 μm, and more preferably 1 to 30 m. In the present specification, the volume average particle size of the inorganic filler is specifically measured by a dynamic light scattering nanotrac particle size analyzer.

Examples of commercial products of inorganic fillers include high-purity synthetic spherical silica (SO-E5, average particle size: 2 m; SO-E2, average particle size: 0.6 μm, both produced by Admatechs), silica (FB7SDX produced by Tatsumori Ltd., average particle size: 10 m), silica (TS-10-034P produced by Micron, average particle size: 20 m), and the like.

The cationically polymerizable epoxy resin composition of the present invention comprises an inorganic filler in an amount of, for example, 40 to 80 wt. %, and preferably 50 to 70 wt. %, based on the entire cationically polymerizable epoxy resin composition.

### (D) Other Components

The cationically polymerizable epoxy resin composition of the present invention may further comprise one or more other components, if necessary.

Specific examples of other components include oxetane resins. Particularly in terms of imparting flexibility to a cured product, when a glycidyl ether epoxy resin or a glycidyl ester epoxy resin is contained, the cationically polymerizable epoxy resin composition of the present invention preferably further comprises an oxetane resin, which promotes the curing of these epoxy resins by the acid generator.

The cationically polymerizable epoxy resin composition of the present invention comprises an oxetane resin in an amount of, for example, 3 to 60 wt. %, and preferably 5 to 50 wt. %, based on the entire cationically polymerizable epoxy resin composition.

Examples of other components further include adhesive adjuvants (e.g., silane), coupling agents (e.g. titanate), rheology adjusting agents (e.g., fumed silica), and the like.

Even if a pigment is not contained, the cationically polymerizable epoxy resin composition of the present invention can be efficiently cured with visible or infrared laser. The cationically polymerizable epoxy resin composition of the present invention may comprise a pigment, if necessary.

### Use

The cationically polymerizable epoxy resin composition of the present invention can be used for curing with visible or infrared laser. In the present invention, the visible or infrared laser specifically refers to those having a wavelength of 600 to 1200 nm. The cationically polymerizable epoxy resin composition of the present invention can be used for curing with laser having a wavelength of preferably 800 to 1100 nm, and more preferably 900 to 1100 nm.

The cationically polymerizable epoxy resin composition of the present invention is preferably used for camera module assembly. More specifically, in camera module assembly, the cationically polymerizable epoxy resin composition of the present invention is preferably used to bond a lens holder and a substrate to which an imaging element is fixed. In the above, the camera module is not particularly limited, and is, for example, a small camera module used for smartphones etc.

Further, the cationically polymerizable epoxy resin composition of the present invention is also preferably used for electronic sensor assembly.

### Examples

Resin compositions of Examples 1 and 2 and Comparative Examples 1 to 4 were prepared by mixing components at composition ratios shown in Table 1. (Numerical values in Table 1 are expressed in terms of mg.) Specifically, components were blended at an arbitrary ratio, kneaded and dispersed using a three-roll mill, and further vacuum-defoamed to obtain a resin composition.

More specifically, the following components were used.
Alicyclic epoxy resin: (3′,4′-epoxycyclohexane)methyl 3,4-epoxycyclohexylcarboxylate (Celloxide 2021 (CEL2021P), produced by Daicel Corporation).
Glycidyl ether: Bisphenol A epoxy resin (EPICLON 840, produced by DIC Cororation)
Oxetane resin: 3-ethyl-3{[(3-ethyloxetan-3-yl)methoxy]methyl}oxetane (OXT 221, produced by Toagosei Co., Ltd.)
Acid generator: thermal acid generator (TGA CXC1821, produced by King Industries, Inc.)
Filler: high-purity synthetic spherical silica (SO-E5, produced by Admatechs, average particle size: 2 m)
Curing Agent 1: Latent polyamine curing agent (EH-5057P, produced by ADEKA Corporation)
Curing agent 2: Acid anhydride (MHAC-P, produced by Showa Denko K.K.)
Pigment: Carbon black (MA100, produced by Mitsubishi Gas Chemical Company, Inc.)
Acrylate resin: Bisphenol A diacrylate (SR-540, produced by Sartomer)
Peroxide: organic peroxide, a polymerization initiator (Per Octa-O, produced by NOF Corporation).

A curing test was performed in the following manner. Table 1 shows the results of evaluation.

### Curing Test Method

Each epoxy resin composition was applied in an amount of 0.01 cc to a glass slide. The resulting glass slides were irradiated with a 980-nm laser at an angle of 90° using CB1F produced by Panasonic Corporation, and then evaluated in terms of appearance and curability of bamboo sticks by touch.

TABLE 1

| | | Cationically | | | | |
|---|---|---|---|---|---|---|
| | | polymerizable | | | | Acrylic resin |
| | | epoxy | Anionically polymerized epoxy composition | | | composition |
| | | composition | Comparative | Comparative | Comparative | Comparative |
| | | Example 1 | Example 1 | Example 2 | Example 3 | Example 4 |
| Alicyclic epoxy | | 100 | — | — | — | — |
| resin | | | | | | |
| Glycidyl ether | | 100 | 100 | 100 | 100 | — |
| Oxetane resin | | 100 | — | — | — | — |
| Acid generator | | 3 | — | — | — | — |
| Acrylate resin | | — | — | — | — | 100 |
| Peroxide | | — | — | — | — | 1 |
| Curing agent 1 | | — | 50 | 50 | — | — |
| Curing agent 2 | | — | — | — | 89 | — |
| Pigment (wt. %) | | — | — | 1 | 3 | — |
| | | | | (0.5) | (0.5) | |
| Filler (wt. %) | | 500 | 68 | 68 | 333 | 50 |
| | | (60) | (30) | (30) | (60) | (30) |
| Curing | After 5 | Cured | Not cured | Carbonized | Not cured | Not cured |
| test | seconds of | | | | | |
| results | irradiation | | | | | |
| | After 7 | Unexamined | Unexamined | Unexamined | Cured | Not cured |
| | seconds of | | | | | |
| | irradiation | | | | | |

When the anionic epoxy resin composition of Comparative Example 1 was irradiated with a laser, curing did not occur. When the anionic epoxy resin compositions of Com-parative Examples 2 and 3 containing carbon black were irradiated with a laser, carbonization or curing was observed. When the acrylic resin composition of Comparative Example 4 was irradiated with a laser, curing did not occur.

In contrast, when the cationic epoxy resin composition of Example 1 was irradiated with a laser, curing was observed after 5 seconds despite the composition containing no pigments. The results show that the cationic epoxy resin composition of Example 1 cures in a shorter time and with less energy than the resin compositions of the Comparative Examples containing no pigments.

1. A visible-laser-curable or infrared-laser-curable cationically polymerizable epoxy resin composition comprising:
(A) an epoxy resin; and
(B) an acid generator.

2. The cationically polymerizable epoxy resin composition according to claim 1, wherein the epoxy resin (A) comprises an alicyclic epoxy resin.

3. The cationically polymerizable epoxy resin composition according to claim 2, wherein the epoxy resin (A) further comprises a glycidyl ether epoxy resin.

4. The cationically polymerizable epoxy resin composition according to claim 1, being curable at a visible or infrared laser having a wavelength of 600 to 1200 nm.

5. The cationically polymerizable epoxy resin composition according to claim 1, further comprising:
(C) an inorganic filler.

6. The cationically polymerizable epoxy resin composition according to claim 1, wherein the acid generator is a photoacid generator or a thermal acid generator.

7. A metal substrate, camera module assembly, and/or electronic sensor assembly comprising the cationically polymerizable epoxy resin composition according to claim 1.

8. Cured reaction products of the cationically polymerizable epoxy resin composition according to claim 1.

9. A method of curing a cationically polymerizable epoxy resin composition, comprising:
providing a cationically polymerizable epoxy resin composition comprising:
(A) an epoxy resin; and
(B) an acid generator;
disposing the cationically polymerizable epoxy resin composition on a substrate; and
irradiating the cationically polymerizable epoxy resin composition with a visible or infrared laser to cure the composition.
